(19) United States
(12) Patent Application Publication
(10) Pub. No.: US 2005/0183853 A1
(43) Pub. Date: Aug. 25, 2005

(54) Device for optimizing the production of gaseous nitrogen using hollow fiber separation membranes

(76) Inventor: Ottavio Milli, Grosseto (IT)

Correspondence Address: NATH & ASSOCIATES, 1030 15th STREET, NW, 6TH FLOOR, WASHINGTON, DC, 20005, US

(21) Appl. No.: 10/848,061

(22) Filed: May 19, 2004

(30) Foreign Application Priority Data
Feb. 24, 2004 (IT) BO2004A000107

(51) Int. Cl. B01D 46/46

(52) U.S. Cl. 165/185

(57) ABSTRACT

A device for optimizing the production of nitrogen obtained from compressed air using hollow fiber separation membranes, in which a flow of preheated compressed air is destined for the separation membrane and heats up the outside of the membrane.

### BACKGROUND OF THE INVENTION

The present invention relates to the sector for the production of nitrogen obtained from air, using hollow fiber separation membranes.

It is known that air separation systems for the production of nitrogen which use hollow fiber membranes need hot air so that the fiber can reach the optimum performance required for the quality and/or quantity of nitrogen produced.

It is also known that module efficiency will only actually be achieved when the air infeed temperature and external temperature conditions have stabilized along the entire length, giving maximum performance and optimum air consumption, considering that the optimum air infeed temperature normally ranges from 24° C. to 60° C. with pressures between 4 and 20 bar/G.

For this purpose, preheating systems are known, which allow treatment of the air destined for the membrane at a controlled temperature, and, to heat the outside of the membrane, heated cabinets in which the module can be placed, or heating cables arranged around the membrane modules.

However, the systems currently known are inefficient, expensive and are not very advantageous in technical terms.

On this subject it is important to consider that there are many membranes on sale with a length which may vary between 20 cm and approximately 2 m in which, during separation, the preheated air which passes through the membrane tends to cool as it moves away from the air inlet.

Consequently, particularly for “long” modules, the membrane fibers work in conditions increasingly distant from the optimum conditions, with a negative effect on overall system efficiency.

Therefore, the sector badly needs a solution which allows optimum nitrogen production using hollow fiber membranes and starting with compressed air, so as to almost instantly (i.e.: within several seconds, for example 5-10 seconds after air infeed) produce gaseous nitrogen in the preset quantity and concentration.

Moreover, to make the membrane module fully efficient, the temperature must be controlled outside the module, along its entire length, at the preheated air infeed temperature.

In particular, a device is needed to optimize the production of nitrogen with membranes which is both efficient and consumes little energy, with a minimum transient time for achieving the “performance” set.

### SUMMARY OF THE INVENTION

The aim of the present invention is, therefore, to overcome the disadvantages of the known systems, using an apparatus as described in the main claim herein.

The apparatus disclosed allows very efficient use of the hot air destined for the fibers, which at the same time is used to evenly heat the membrane from the outside.

Further advantageous aspects of the invention are described in the dependent claims and consist of geometric simplicity, compact dimensions and simple construction, which may be adapted for modular use.

Moreover, it may be advantageous to fit the membrane outlet with a flow control valve of the “back pressure regulator” type which, when the back pressure at module outlet changes, allows the flow of nitrogen, already calibrated according to the pressure of the air fed in, to be kept constantly at the optimum value set, further improving membrane efficiency.

Further advantages consist of the fact that after starting the compressed air generator, there is a very short transient time, meaning that the system is quickly operative and at optimum operating conditions.

To this end, it is important to consider that once the operating temperature has been reached, to obtain the required quality and quantity of nitrogen just a few seconds (5-10 seconds) are required, compared with transient times of one hour or more for known systems.

Advantageously, the system disclosed also allows the start of heating to be timed so as to save energy during the periods when it is not used.

The present invention also relates to a method for the production of nitrogen using hollow fiber membranes, in which the air to be separated is preheated, and in which said heated air is also used to bring the entire membrane to the required temperature and keep it there.

According to another aspect of the invention, the heat of the permeate (air rich in oxygen), fed out of the module at the same temperature as the air fed in, may be recovered and used to evenly balance the temperature outside the module.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is an exploded view of a first embodiment of the invention, with some parts cut away to illustrate internal details;

FIG. 1a is a top view of the invention illustrated in FIG. 1;

FIGS. 2a, b are respectively a sectional side view and a top view of a second embodiment of the invention;

FIG. 3 is a schematic illustration of a device according to the present invention, fitted on a screw compressor.

### DESCRIPTION OF THE PREFERRED EMBODIMENTS

With reference to the accompanying drawings, a preferred embodiment of the invention is described.

In this embodiment, the device disclosed comprises a hollow body 1 (preferably extruded aluminum or another heat-conducting material), open at least at one end so that its internal compartment 17 can house one or more membrane modules 2, preferably with a ring-shaped outer air gap 15, closed by corresponding lids 4, 5 at the ends of the body 1.

The outer shape of the body 1 is preferably rectangular or square, with engagement profiles 13 making the device suitable for modular use and/or for application on the structure of various apparatuses (e.g.: air compressors).

However, other prismatic or curved geometries may be used, according to construction requirements.

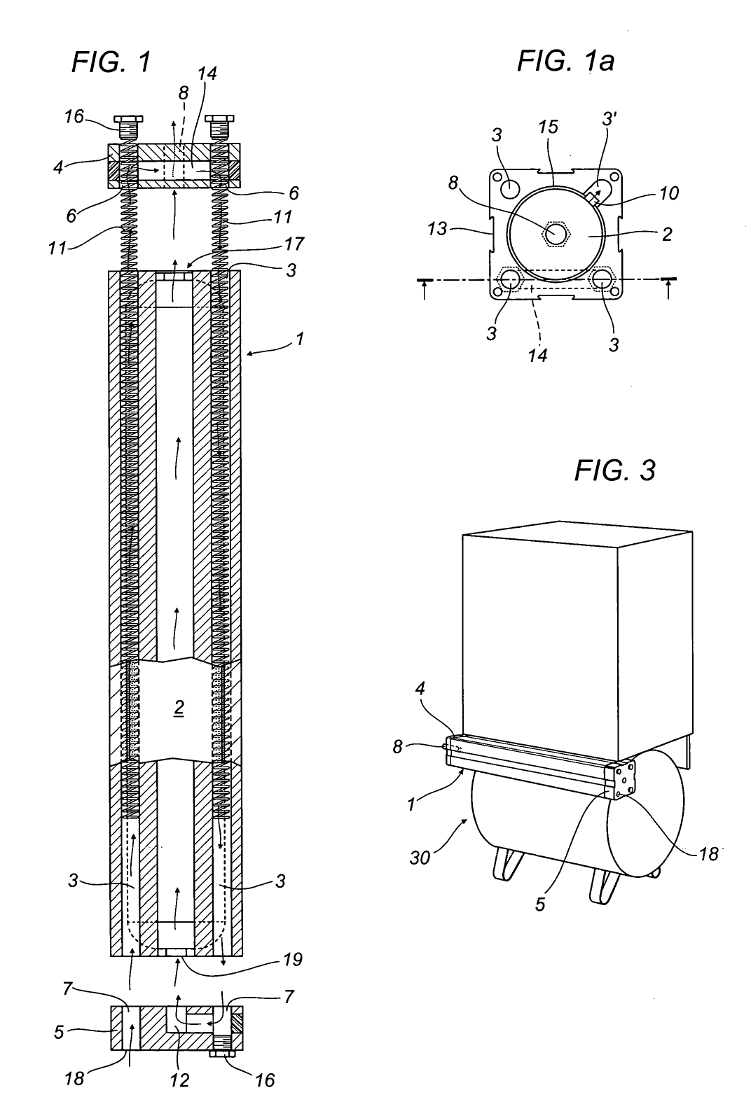

With reference to FIG. 1, there is at least one hole 3 in the body 1, but preferably two or more holes, for the passage of a flow of hot air. In particular, in the example described the body 1 is square and has four through-holes 3, 3′, positioned longitudinally close to its vertices.

The holes may have a different shape and course (e.g.: curved, or spiral) according to the geometry and production technique of the body 1 and its industrial application.

With reference to the accompanying drawings, the lids 4 and 5 are applied to the body 1 in a known way, so that the holes 6, 7 in the lids correspond with the ends of the holes 3 in the body 1.

Moreover, there is a hole 8 in at least one of the two lids (in the case described, the upper lid 4), corresponding to the outlet 20 for the nitrogen separated by the membrane 2 and one transversal communicating hole 14 located between a pair of holes 3 positioned along the same side of the body 1, whilst in the other lid 5 there is a communicating hole 12 between one of the holes 3 and the air inlet 19 into the membrane.

The internal connections between the membrane 2 and the ducts 8 and 12 are of the known type and so not described in further detail.

One of the holes 3 (labeled 3′ in the figure) preferably opens into the inside of the body 1, so that it coincides with the outlet 10 for discharge of the permeate from the membrane 2, normally positioned on one side of the membrane.

A heating element 11 is inserted in at least one of the holes 3 (in the preferred embodiment illustrated in FIG. 1, in two of the holes 3 located on the same side of the body 1). The heating element preferably consists of an electrical resistor with a spiral exchange surface, having a threaded plug 16 which can engage with internal threading in the holes 6, 7 in the lids 4, 5.

Advantageously, with this heating element configuration optimum heat exchange is achieved between the heating element and the air flow to be heated and destined for the membrane.

In practice, the compressed air to be separated is sent from the inlet 18 communicating with a first hole 3 (the hole on the left in FIG. 1) so that it heats up when it makes contact with the heating element 11 then passes into the second hole 3, which also has a heating element 11, passing through the communicating hole 14 in the upper lid 4.

At the lower lid 5, the air passing through the right-hand hole 3 (in FIG. 1) enters the communicating duct 12, and from here enters the membrane 2 air inlet 19.

When separation is complete, the nitrogen produced exits the membrane outlet 20 communicating with the duct 8 in the lid 4, whilst the permeate (air rich in oxygen) from the discharge outlet 10 is channeled along the hole 3′ (preferably closed at one end with a plug 16) then discharged to the outside, normally into an open environment.

Advantageously, since aluminum is a material which conducts heat very well, the heat emitted by the heating elements spreads to the entire body 1, rapidly bringing the membrane to the same temperature as the air fed into the module 2.

Moreover, the permeate, at the same temperature as the air fed into the module, as it passes through the hole 3′ goes into the ring-shaped air gap 15 (if present), and helps to create a hot chamber at a controlled temperature around the membrane, also contributing to overall energy savings by recovery of the heat lost by the permeate which would otherwise be dispersed into the environment.

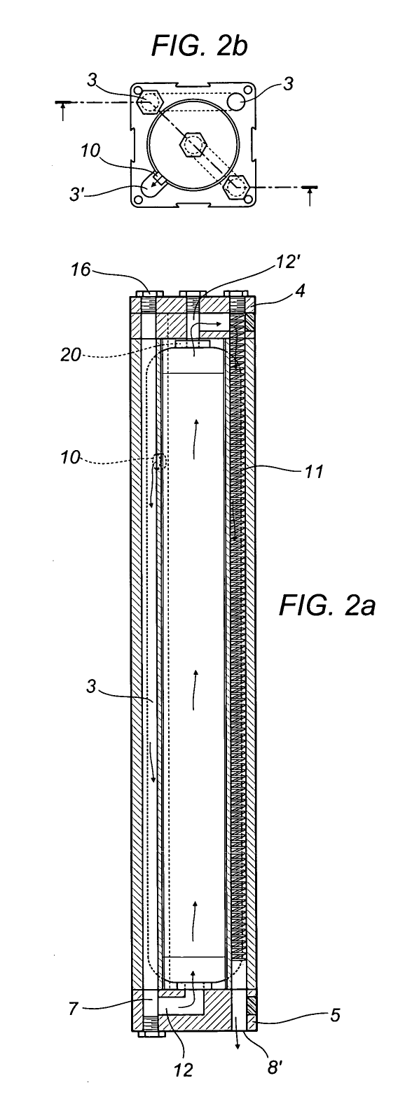

FIGS. 2a and 2b illustrate an alternative path for the separated nitrogen.

In this embodiment, the lid 4 does not have the outlet hole 8 in it. Instead, is has a transversal communicating hole 12′ which carries the separated nitrogen to a third hole 3, also fitted with a heating element 11.

In this case, the lower lid 5 has an outlet hole 8′ corresponding to the hole 3 through which the nitrogen passes.

Advantageously, the temperature of the nitrogen may be controlled as required, meaning that the invention is particularly efficient for the production of nitrogen which will be used as a carrier gas in spray painting systems.

From the above description it is evident that the present invention allows the membrane to be heated extremely rapidly, which means that the device may be used for the quality and quantity required, eliminating the long waits before reaching operating conditions seen in known systems.

The preferable operating temperature is within the range from 24° to 60° C., but it is understood that different temperatures may be used according to the technical specifications of the membranes chosen and the application (i.e.: quality level/quantity of nitrogen produced).

Moreover, the nitrogen outlet 8, 8′ may also be fitted with a flow control valve of the “Back Pressure Regulator” type, which allows optimum flow (and quality) conditions to be maintained even if there are changes in the back pressure at the module outlet, for example when filling a tank that was initially empty with the nitrogen produced.

This type of valve is a commercial type and so is not described in further detail.

In the description reference is made in particular to a system equipped with its own heating elements. However, the invention may also avoid the use of heating elements and use a flow of compressed air which is already hot, circulating it through the holes 3 in the body 1 until it goes into the membrane 2, as described above.

For example, this may be the case when the device disclosed is connected to a screw compressor 30 (FIG. 3), transferring the hot air produced from the screw directly into the holes in the body 1.

Other advantageous applications of the invention are combined with machines which require gaseous nitrogen on board the machine, such as machines for packaging food products, filling machines for wine, edible oil, herbal products, processing systems in general in the chemical and pharmaceutical sectors, in the tire and tire changing sector, as well as in the spray painting sector already mentioned, promoting the “blocking” of paint on the surface to be painted and doing this advantageously when the paint is on a vertical wall, preventing drips, in particular in robotized painting systems.

At present, due to cost and size, filling machines for wine or oil are supplied by a single nitrogen generator, which means that any malfunction or interruption in the nitrogen supply stops operations on all machines.

Advantageously, the use of the device disclosed allows autonomous management of the filling machines and machines in general.

The invention may have evident industrial applications. It can be subject to modifications and variations without thereby departing from the scope of the inventive concept and all the details of the invention may be substituted by technically equivalent elements.

1. A device for optimizing the production of nitrogen obtained from compressed air using hollow fiber separation membranes, comprising means for heating a flow of compressed air destined for a separation membrane, and means for heating the outside of the membrane using heat exchange with the heated air flow.

2. The device according to claim 1, wherein it comprises a hollow body made of a heat-conducting material and suitable for housing at least one membrane module with thermal contact, in which the means for heating the compressed air destined for the membrane comprise at least one duct for the hot air flow, made in the body to heat the membrane housed in the body.

3. The device according to claim 2, wherein the body has a compartment in it, for housing at least one membrane module, and at least one hole for the passage of the hot air flow destined for the membrane.

4. The device according to claim 3, wherein the means for heating the compressed air comprise at least one heating element housed in said duct.

5. The device according to claim 4, wherein the heating element consists of a spiral resistor positioned in the duct in such a way that it is struck by the air flow destined for the membrane.

6. The device according to claim 1, wherein a plurality of flow holes are made in the body, communicating with one another by means of ducts, so that the flow of compressed air destined for the membrane flows though them in succession, at least one of the holes having an inlet for the compressed air to be heated and at least one having a duct for the heated air communicating with the air inlet of a membrane housed in the container, the body also having an outlet which can communicate with the outlet for the nitrogen separated by the membrane.

7. The device according to claim 6, wherein one of the holes communicates with the compartment so that it can correspond with an outlet for the permeate located on one side of the membrane.

8. The device according to claim 6, wherein the body comprises two removable end lids having holes corresponding to said holes, and wherein the communicating ducts for the heated air are made in the lids.

9. The device according to claim 6, wherein it comprises a communicating duct extending from the outlet for the nitrogen produced by the membrane to a flow hole having an element for heating the nitrogen flow and an outlet for the heated nitrogen.

10. The device according to claim 2, wherein the body has engagement profiles, to allow the modular arrangement of two or more devices.

11. The device according to one claim 2, wherein the body is four-sided and is made of extruded aluminum.

12. A method for optimizing the production of nitrogen using hollow fiber membranes, comprising the steps of feeding a flow of heated compressed air to at least one membrane module and heating the outside of the module using the same flow of hot air.

13. The method according to claim 12, in which the heat of the permeate gas exiting the module is recovered and used to heat the outside of the membrane.

14. A screw compressor, comprising a device according to claim 1, in which the device is mounted on board the compressor and the flow of hot air is the flow of compressed air produced by the screw.

15. A filling machine for wine or edible oil, wherein it is equipped with a device according to claim 1.
